(19) United States
(12) Patent Application Publication
(10) Pub. No.: US 2011/0111322 A1
(43) Pub. Date: May 12, 2011

(54) FUEL CELL ELECTRODE CATALYST, METHOD FOR EVALUATING PERFORMANCE OF OXYGEN-REDUCING CATALYST, AND SOLID POLYMER FUEL CELL COMPRISING THE FUEL CELL ELECTRODE CATALYST

(76) Inventor: Yukiyoshi Ueno, Shizuoka (JP)

(21) Appl. No.: 12/671,925

(22) PCT Filed: Aug. 8, 2008
(86) PCT No.: PCT/JP2008/064608

§ 371 Date: Feb. 3, 2010

(30) Foreign Application Priority Data
Aug. 9, 2007 (JP) 2007-208-458

(51) Int. Cl. H01M 4/92; H01M 8/10; H01M 8/00

(52) U.S. Cl. 429/487; 429/526; 429/535

(57) ABSTRACT

According to the present invention, a fuel cell electrode catalyst comprising a transition metal element and a chalcogen element and having high activity is provided with an index for performance evaluation that is useful for good catalyst design. Also, a fuel cell electrode catalyst is provided, such catalyst comprising at least one transition metal element and at least one chalcogen element which are supported by a conductive carrier, wherein the value of (average electrode catalyst particle size (nm))/(electrode catalyst particle size distribution (%)) is 0.013 to 0.075.

### TECHNICAL FIELD

The present invention relates to a fuel cell electrode catalyst comprising at least one transition metal element and at least one chalcogen element, which can replace a conventional platinum catalyst, a method for evaluating performance of an oxygen-reducing catalyst, and a solid polymer fuel cell comprising such fuel cell electrode catalyst.

### BACKGROUND ART

Anode catalysts used for polymer electrolyte fuel cells are mainly platinum and platinum-alloy-based catalysts. Specifically, catalysts in which a platinum-containing noble metal is supported by carbon black have been used. In terms of practical applications of polymer electrolyte fuel cells, one problem relates to the cost of materials. A means to solve such problem involves reduction in the platinum content.

Meanwhile, it has been known that when oxygen (O₂) is electrolytically reduced, superoxide is generated as a result of one-electron reduction, hydrogen peroxide is generated as a result of two-electron reduction, or water is generated as a result of four-electron reduction. When voltage reduction occurs for some reason in a fuel cell stack using, as an electrode, a platinum or platinum-based catalyst, four-electron reduction performance deteriorates, resulting in two-electron reduction. Accordingly, hydrogen peroxide is generated, causing MEA deterioration.

Recently, low-cost fuel cell catalysts have been developed via a reaction that produces water as a result of four-electron reduction of oxygen, which will result in elimination of the need for expensive platinum catalysts. Non-Patent Document 1 described below discloses that a catalyst comprising a chalcogen element is excellent in terms of four-electron reduction performance and suggests that such catalyst be applied to fuel cells.

Likewise, Patent Document 1 described below discloses, as a platinum (Pt) catalyst substitute, an electrode catalyst comprising at least one transition metal and a chalcogen. An example of a transition metal is Ru and an example of a chalcogen is S or Se. It is also disclosed that, in such case, the Ru:Se molar ratio is from 0.5:1 to 2:1 and the stoichiometric number “n” of (Ru)nSe is 1.5 to 2.

Further, Patent Document 2 described below discloses, as a Pt catalyst substitute, a fuel cell catalyst material comprising a transition metal that is either Fe or Ru, an organic transition metal complex containing nitrogen, and a chalcogen component such as S.

In addition, Non-Patent Document 1 described below discloses an Mo—Ru—Se ternary electrode catalyst and a method for synthesizing the same.

Further, Non-Patent Document 2 described below discloses Ru—S, Mo—S, and Mo—Ru—S binary and ternary electrode catalysts and methods for synthesizing the same.

Furthermore, Non-Patent Document 3 described below discloses Ru—Mo—S and Ru—Mo—Se ternary chalcogenide electrode catalysts.
Patent Document 1: JP Patent Publication (Kohyo) No. 2001-502467 A
Patent Document 2: JP Patent Publication (Kohyo) No. 2004-532734 A
Non-Patent Document 1: Electrochimica Acta, vol. 39, No. 11/12, pp. 1647-1653, 1994
Non-Patent Document 2: J. Chem. Soc., Faraday Trans., 1996, 92 (21), 4311-4319
Non-Patent Document 3: Electrochimica Acta, vol. 45, pp. 4237-4250, 2000

### DISCLOSURE OF THE INVENTION

### Problem to be solved by the Invention

The catalysts disclosed in Patent Document 1 and Non-Patent Documents 1, 2, and 3 are insufficient in terms of four-electron reduction performance. Therefore, the development of high-performance catalysts and of an index for performance evaluation that is useful for high-performance catalyst design has been awaited.

### Means for Solving Problem

In general, it is thought that surface areas of active sites in a catalyst can be increased by reducing catalyst particle size. However, in cases of chalcogenide-based catalysts, highly active catalysts cannot be obtained simply by reducing the particle sizes thereof. The present inventors have found that, in the case of a fuel cell electrode catalyst comprising a transition metal element and a chalcogen element that are supported by a conductive carbon carrier, the specific parameter ratio is closely related to the oxygen reduction performance of such catalyst. Further, they have found that the above problem can be solved by designating such ratio as an index for performance evaluation that is useful for catalyst design. This has led to the completion of the present invention.

Specifically, in a first aspect, the present invention relates to a fuel cell electrode catalyst comprising at least one transition metal element and at least one chalcogen element (X) which are supported by a conductive carrier, characterized in that the value of (average electrode catalyst particle size (nm))/(electrode catalyst particle size distribution (%)) is 0.013 to 0.075.

In a preferred example of the fuel cell electrode catalyst of the present invention, a transition metal element to be used is at least one selected from the group consisting of ruthenium (Ru), molybdenum (Mo), osmium (Os), cobalt (Co), rhodium (Rh), iridium (Ir), iron (Fe), nickel (Ni), titanium (Ti), palladium (Pd), rhenium (Re), tungsten (W) and a chalcogen element to be used is at least one selected from the group consisting of sulfur (S), selenium (Se), and tellurium (Te).

Particularly preferably, the transition metal elements are ruthenium (Ru) and molybdenum (Mo) and the chalcogen element (X) is sulfur (S).

Herein, the ratio of (average electrode catalyst particle size) to (electrode catalyst particle size distribution) derived from an electrode catalyst is determined based on the composition ratio of one component to the other, the nature of a crystal of catalyst particles, and the like. In addition, it is possible to change crystallographic activity, particle-size-dependent activity, and the like of such catalyst particles mainly based on conditions of baking after catalyst preparation.

In a second aspect, the present invention relates to a method for evaluating performance of an oxygen-reducing catalyst represented by a fuel cell electrode catalyst, characterized in that the value of (average electrode catalyst particle size)/(electrode catalyst particle size distribution) is used as an index of catalyst performance for a fuel cell electrode catalyst comprising at least one transition metal element and at least one chalcogen element (X) which are supported by a conductive carrier. In particular, excellent catalyst activity is exhibited when the value of (average electrode catalyst particle size (nm))/(electrode catalyst particle size distribution (%)) is 0.013 to 0.075.

As described above, in a preferred example of the present invention, the above transition metal element is at least one selected from the group consisting of ruthenium (Ru), molybdenum (Mo), osmium (Os), cobalt (Co), rhodium (Rh), iridium (Ir), iron (Fe), nickel (Ni), titanium (Ti), palladium (Pd), rhenium (Re), and tungsten (W) and the above chalcogen element is at least one selected from the group consisting of sulfur (S), selenium (Se), and tellurium (Te).

In a third aspect, the present invention relates to a solid polymer fuel cell comprising the above fuel cell electrode catalyst.

### Effects of the Invention

The fuel cell electrode catalyst of the present invention has a higher level of four-electron reduction performance and higher activity than a conventional transition metal-chalcogen element-based catalyst, and thus it can serve as a platinum catalyst substitute.

In addition, the technique for obtaining the value of (average electrode catalyst particle size)/(electrode catalyst particle size distribution) used in the present invention is widely useful in the design of oxygen-reducing catalysts.

### BRIEF DESCRIPTION OF THE DRAWINGS

FIG. 1 shows a TEM image of RuMoS/C (S: 20 mol %).

FIG. 2 shows a TEM image of RuMoS/C (S: 45 mol %).

FIG. 3 shows a TEM image of RuMoS/C (S: 70 mol %).

FIG. 4 shows the results of catalyst particle size measurement (nm).

FIG. 5 shows the results of catalyst particle size distribution measurement (%).

FIG. 6 shows results of oxygen reduction performance evaluation obtained by a rotating ring-disk electrode (RDE) evaluation method.

FIG. 7 shows the relationship between catalyst performance and particle size.

FIG. 8 shows the correlation between catalyst performance and the ratio of particle size to particle size distribution.

FIG. 9 shows the range of the value of (average electrode catalyst particle size (nm))/(electrode catalyst particle size distribution (%)) necessary to obtain an oxygen reduction current value of 1.25E−0.5 or more in FIG. 8.

### BEST MODE FOR CARRYING OUT THE INVENTION

Hereinafter, the present invention is described in more detail with reference to the Examples and the Comparative Examples.

### [Catalyst Preparation]

Ketjen Black (trade name) was used as a carbon carrier. Ruthenium carbonyl, molybdenum carbonyl, and sulfur were heated at 140° C. in the presence of argon, followed by cooling. Thereafter, the resultant was washed with acetone and filtered. The obtained filtrate containing RuMoS/C was baked at 350° C. for 2 hours. Thus, catalysts were prepared. Herein, the sulfur contents were 20, 45, and 70 mol %.

### [Structural Analysis]

The above catalyst material was subjected to structural analysis via EXAFS and TEM.

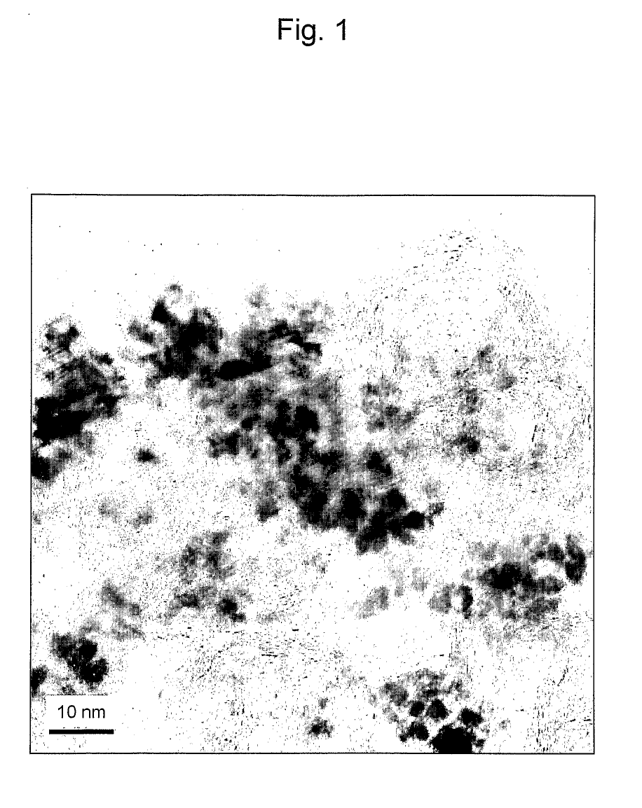

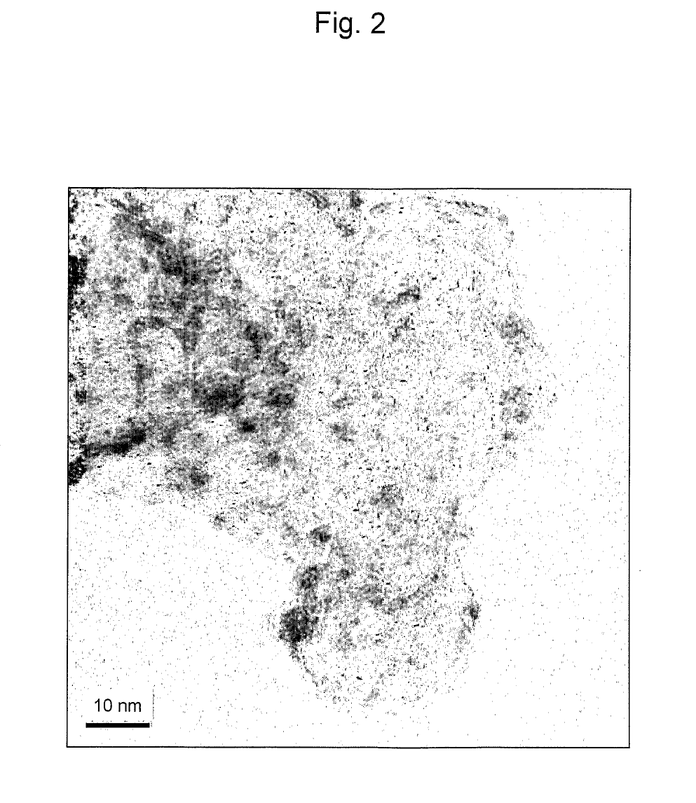

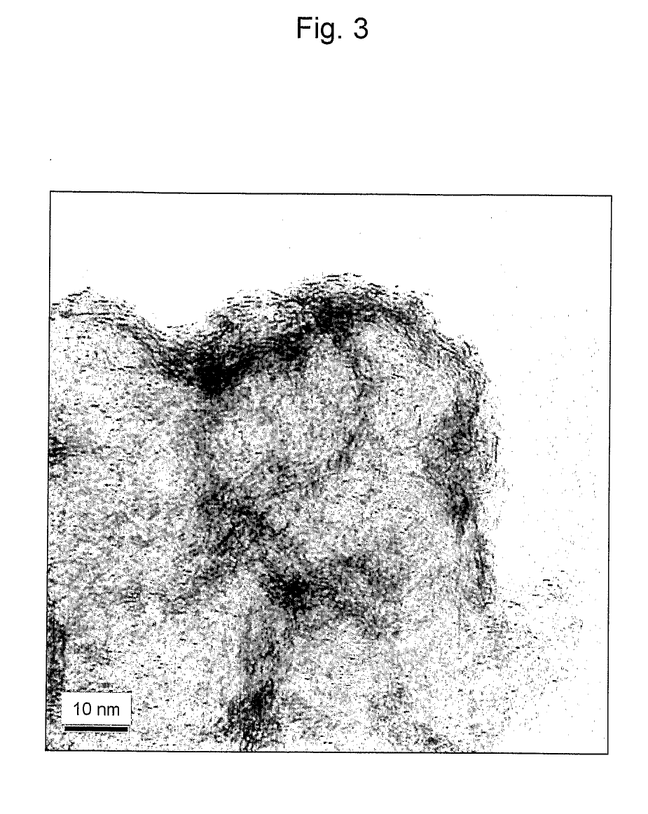

FIG. 1 shows a TEM image of RuMoS/C (S: 20 mol %). Based on the results shown in FIG. 1, crystal particles can be confirmed, indicating a small particle size distribution. FIG. 2 shows a TEM image of RuMoS/C (S: 45 mol %). Based on the results shown in FIG. 2, crystal particle portions and non-crystal portions can be confirmed, indicating a medium particle size distribution. FIG. 3 shows a TEM image of RuMoS/C (S: 70 mol %). Based on the results shown in FIG. 3, crystal particles cannot be confirmed and non-crystal portions alone can be confirmed, indicating a large particle size distribution.

Based on the above TEM observation results, it has been confirmed that a chalcogenide-based catalyst in a certain state (depending on composition, heat treatment conditions, and the like) comprises both non-crystal portions and crystal portions.

### [Structural Analysis and Performance Evaluation of Catalyst Materials Treated Under Different Heat Treatment Conditions]

In addition to the above catalysts, a catalyst obtained by treating RuMoS/C (S: 45 mol %) under a heat treatment condition of 350° C.×1 h and a catalyst obtained by treating RuS/C under a heat treatment condition of 350° C.×2 h were examined in terms of particle size and particle size distribution by a small angle X-ray scattering method.

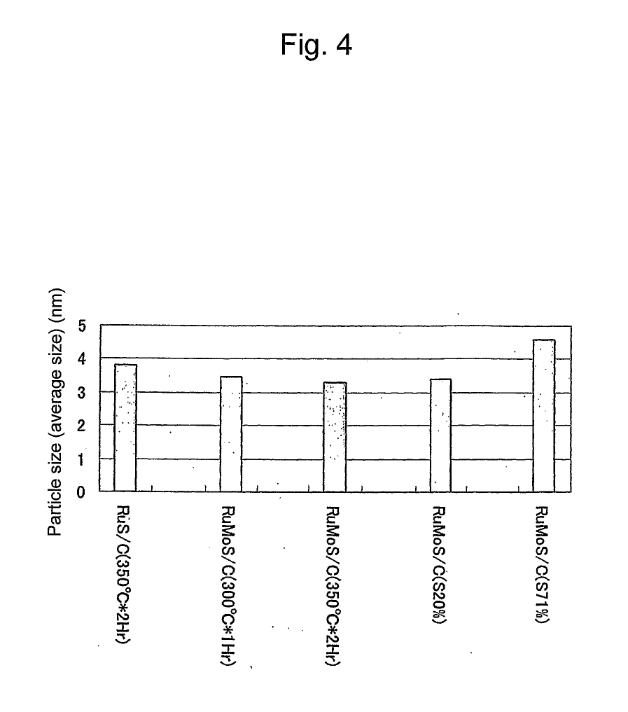

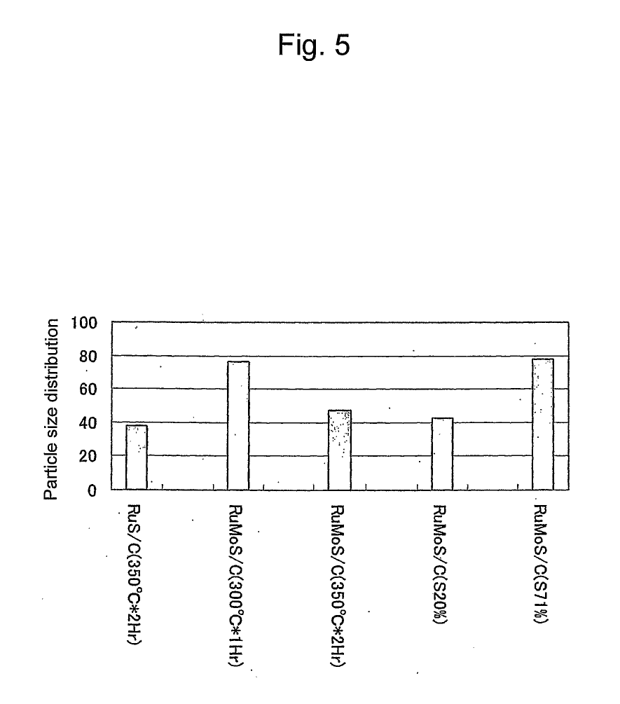

FIG. 4 shows the results of catalyst particle size measurement (nm). In addition, FIG. 5 shows the results of catalyst particle size distribution measurement (%).

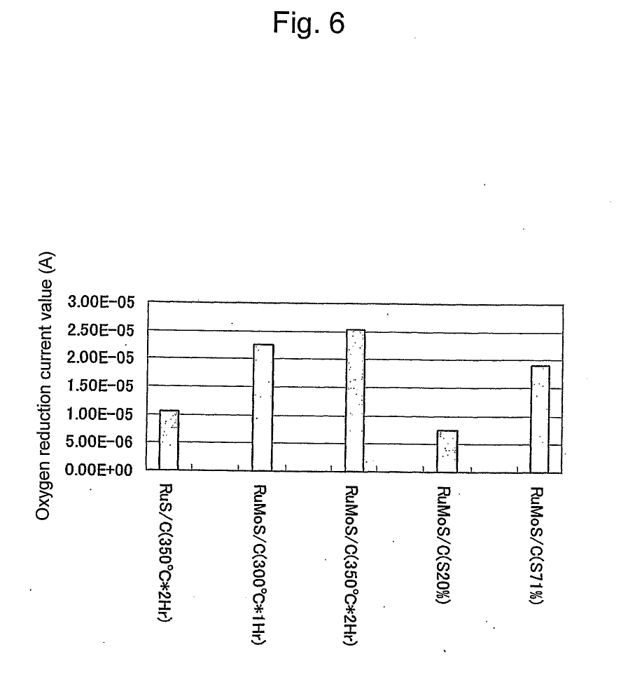

FIG. 6 shows the results of performance evaluation of the catalysts subjected to the above small angle X-ray scattering method. In addition, performance evaluation was carried out by a rotating ring-disk electrode (RDE) evaluation method. The oxygen reduction current value at 0.7 V is designated as the value indicating catalyst performance.

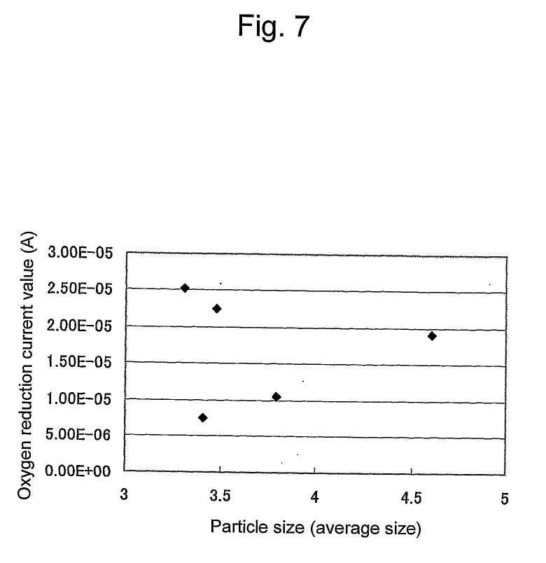

The correlation between the results of catalyst particle size measurement obtained from FIG. 4 and the results of oxygen reduction performance evaluation obtained from FIG. 6 was examined. FIG. 7 shows the relationship between catalyst performance and particle size. As a result, no correlation was confirmed therebetween.

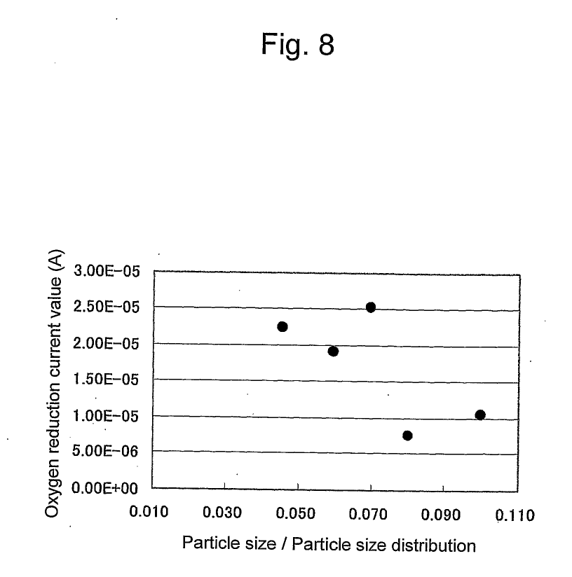

Next, the correlation between the particle size/particle size distribution ratios obtained from FIGS. 4 and 5 and the results of oxygen reduction performance evaluation obtained from FIG. 6 was examined. FIG. 8 shows the relationship between catalyst performance and the particle size/particle size distribution ratio. As a result, no correlation was confirmed therebetween.

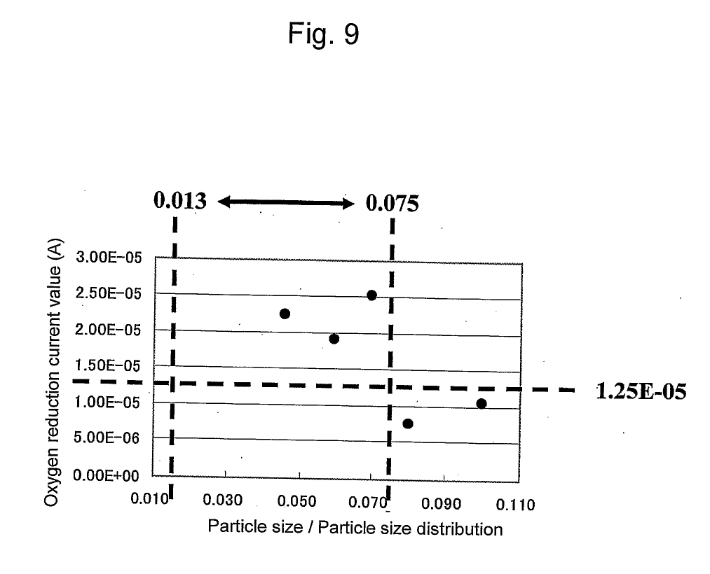

As shown in FIG. 9, it is understood that the range of the value of (average electrode catalyst particle size (nm))/(electrode catalyst particle size distribution (%)) must be 0.013 to 0.075 in order to obtain an oxygen reduction current value of 1.25E−0.5 or more in FIG. 8.

### INDUSTRIAL APPLICABILITY

The fuel cell electrode catalyst of the present invention has a high level of four-electron reduction performance and high activity, and thus it can serve as a platinum catalyst substitute. In addition, the technique for obtaining the value of (average electrode catalyst particle size)/(electrode catalyst particle size distribution) used in the present invention is widely useful in the design of oxygen-reducing catalysts. Therefore, the present invention contributes to the practical and widespread use of fuel cells.

1. A fuel cell electrode catalyst comprising a transition metal element and a chalcogen element which are supported by a conductive carrier, wherein the transition metal element contains ruthenium (Ru) and molybdenum (Mo); the chalcogen element contains sulfur (S) and/or selenium (Se); and the value of (average electrode catalyst particle size (nm))/(electrode catalyst particle size distribution (%)) is 0.013 to 0.075.

2. (canceled)

3. (canceled)

4. (canceled)

5. (canceled)

6. (canceled)

7. A solid polymer fuel cell, which comprises the fuel cell electrode catalyst according to claim 1.

8. A method for manufacturing a fuel cell electrode catalyst comprising a transition metal element and a chalcogen element wherein the transition metal element contains ruthenium (Ru) and molybdenum (Mo), and the chalcogen element contains sulfur (S) and/or selenium (Se), which comprises a step of selecting a composition of the catalyst so as to adjust the value of (average electrode catalyst particle size (nm))/(electrode catalyst particle size distribution (%)) in the range of 0.013 to 0.075.
